(19) United States
(12) Patent Application Publication
(10) Pub. No.: US 2025/0069082 A1
(43) Pub. Date: Feb. 27, 2025

(54) Electronic Devices and Corresponding Methods for Presenting Fraud Warnings for Transaction Reversal Requests

(71) Applicant: Motorola Mobility LLC, Chicago, IL (US)

(72) Inventors: Hariprasad Shanbhogue Alampady, Karnataka (IN); Amit Kumar Agrawal, Bangalore (IN); Bhavana Bhat, Karnataka (IN)

(21) Appl. No.: 18/237,652

(22) Filed: Aug. 24, 2023

(51) Int. Cl. G06Q 20/40

(52) U.S. Cl. CPC G06Q 20/4016; G06Q 20/407

(57) ABSTRACT

An electronic device includes a communication device, a user interface, and one or more processors operable with the communication device and the user interface. In response to the communication device receiving a financial transaction communication and a financial transaction reversal request communication, optionally within a predefined time duration threshold, the one or more processors cause the user interface to deliver a prompt comprising a fraud warning indicating that the financial transaction reversal request is likely fraudulent.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps in either the financial applications of the device or user behavior to commit crimes and steal money. It would be advantageous to have improved devices and systems to prevent situations such as this from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one or more explanatory method steps in accordance with one or more embodiments of the disclosure.

FIG. 2 illustrates one explanatory electronic device in accordance with one or more embodiments of the disclosure.

FIG. 3 illustrates one explanatory server complex in accordance with one or more embodiments of the disclosure.

FIG. 4 illustrates one explanatory method in accordance with one or more embodiments of the disclosure.

FIG. 5 illustrates one or more explanatory method steps in accordance with one or more embodiments of the disclosure.

FIG. 6 illustrates one explanatory signal flow diagram in accordance with one or more embodiments of the disclosure.

FIG. 7 illustrates one or more embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to presenting, in response to receiving an indication that a financial transaction has occurred and that a request to reverse the financial transaction has been received, a prompt comprising a fraud warning indicating that the request to reverse the financial transaction is likely fraudulent. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to a communication device receiving a financial transaction communication and a financial transaction reversal request communication within a predefined time duration threshold, presenting a prompt comprising a fraud warning indicating that the financial transaction reversal request is likely fraudulent as described herein. The non-processor circuits may include, but are not limited to, a radio receiver, a radio transmitter, signal drivers, clock circuits, power source circuits, and user input devices. As such, these functions may be interpreted as steps of a method to perform the presentation of a prompt, in response to receiving a financial transaction reversal request after a financial transaction has occurred, a prompt comprising a fraud warning indicating that the financial transaction reversal request is likely fraudulent.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” In this document, relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, electronic devices, and systems that warn users of fraudulent activity before “request to reverse” financial transactions are completed. As used herein, a “request to reverse” financial transaction is one in which a user receives funds via a financial transaction, and then also receives a request to “reverse” the transaction either by affirmatively reversing it with a financial institution or by initiating a new financial transaction to transfer the funds to another account in an effort to offset the initial transaction (which can include fees or other charges in addition to the initially received funds).

Embodiments of the disclosure contemplate that scammers will sometimes attempt to defraud targets using the following scheme: initially, a fraudster will make a nominal financial transaction to a financial account of a target. Illustrating by example, they may transfer a few dollars to the financial account of the target as if they were reimbursing the target for a small loan, or lunch tab, or similar expense. However, (often quickly) thereafter, the fraudster will call, text, email, or otherwise communicate with the target alleging that the financial transaction was made in error. The fraudster will then make a “request to reverse” the financial transaction since the financial transaction was supposedly made in error. The fraudster will sometimes also ask for a screen shot confirming the reversal. Since this screen shot likely includes details regarding the target's name, bank account, or other sensitive information, the fraudster is then able to steal larger sums of money from the target using this information.

In short, the scheme is to make a small financial transaction to a target, allege that the financial transaction was made in error, request the financial transaction be reversed, also request a screen shot of the financial transaction reversal, and then steal. Consider the following example:

Paul is eighty years old and normally employs his smartphone to make digital payments. One day he receives twenty-five dollars from an unknown account belonging to an unknown contact. While wondering where on earth this financial transaction came from, Paul receives a call from a stranger stating that the financial transaction to Paul was made by mistake. Instead of sending the twenty-five dollars to a friend, the caller alleges to have mistakenly sent it to Paul.

Now presume that the caller claims to be a senior citizen who is not experienced with digital payments and their associated processes. Consequently, the caller requests that Paul reverse the transaction by initiating a new financial transaction to return the twenty-five dollars. The caller provides account details regarding the account to which the twenty-five dollars should be sent. Paul, being a kind and decent person, executes a new financial transaction sending twenty-five dollars to the caller's account. To confirm the transaction, the caller asks Paul to send a screenshot of the transaction that includes the name and account details as confirmation of the return payment.

Sadly, Paul complies with this last request and sends not only the twenty-five dollars, but also the screenshot revealing important and sensitive details concerning his account. After a few days he discovers that the caller was a scammer and has hacked into his electronic financial account. The scammer made several transactions without Paul's knowledge.

Advantageously, embodiments of the disclosure provide a solution to this problem that would have presented a prompt to Paul warning him that the request he received by phone was likely fraudulent. In one or more embodiments, a communication device of an electronic device receives first electronic signals delivering an indication that a financial transaction has occurred in a financial account of an authorized user of an electronic device. In one or more embodiments, the communication device also receives second electronic signals delivering a request that the financial transaction be reversed.

In one or more embodiments, in response to receiving the first electronic signals and the second electronic signals, one or more processors of the electronic device present a prompt comprising a fraud warning indicating that the request to reverse the financial transaction is likely fraudulent. Advantageously, had Paul been using an electronic device configured in accordance with one or more embodiments of the disclosure, he would have received a prompt indicating that the caller's request to reverse the financial transaction was likely fraudulent. This would have stopped Paul from making the reverse financial transaction. It also would have saved Paul from being scammed.

In one or more embodiments, an electronic device comprises a communication device, a user interface, and one or more processors operable with the communication device and user interface. In one or more embodiments, in response to the communication device receiving a financial transaction communication and a financial transaction reversal request communication within a predefined time duration threshold, the one or more processors cause the user interface to deliver a prompt comprising a fraud warning indicating that the financial transaction reversal request is likely fraudulent.

Advantageously, embodiments of the disclosure alert a potential fraud victim that a financial transaction reversal request received in close time proximity to a financial transaction is likely fraudulent before a new financial transaction reversing the initial financial transaction is executed. This allows the potential fraud victim to avoid becoming an actual fraud victim.

Embodiments of the disclosure contemplate that many modem electronic devices include both financial applications and shopping applications. Illustrating by example, Motorola Mobility has launched a banking application called DIMO.sup.™ in Brazil. This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.™ are leading to users simply ceasing to carry paper currency or coins. Moreover, applications like DIMO.sup.™ have caused people to stop carrying physical credit and debit cards as well since the credit and debit card account information can simply be loaded into a smartphone, with near-field and other communication devices allowing direct transactions of money electronically.

Embodiments of the disclosure also contemplate that ensuring that such financial applications are fully fraud proof has been challenging in the past. This is true even for well-established financial technology firms. While many additional features and mechanisms have been added to financial applications, examples of which include multi-factor authentication, encryption, and the like, miscreants are still able to make fraudulent transactions. Such transactions seem to be in the news every day.

In many situations, users of financial applications become victims when fraudsters make lucrative offers in phone calls. However, such users can become victims in other ways as well. They may download unsecure applications, visit fraudulent websites, or take other actions where they believe to be acting safely and are instead walking right into the trap of a nefarious actor.

In some situations, victims are made to believe that a caller or messenger is legitimate, only to find that they are really crooks when a financial transaction initiated by the victim is directed to a fraudulent account. Indeed, embodiments of the disclosure are directed to situations in which a fraudster transfers money to a financial account of an authorized user of an electronic device intentionally, only to thereafter asking them to reverse the financial transaction either directly or by paying an equivalent amount of money to an unknown financial account. Embodiments of the disclosure contemplate that bona fide users of the financial system and electronic devices operating in that financial system fall into such traps and not only reverse the financial transaction, but also send a screen shot of the reversal to unknown callers. Fraudsters use these screen shots to steal from the bona fide user. Such a scenario resulted in eighty-one people in Mumbai, India, were actually fooled by this scheme and lost eight-one crore rupees, which equates to 810,000,000 rupees or over 120,000 US dollars.

Embodiments of the disclosure provide a solution to this madness by providing contextually relevant alerts when a potentially fraudulent transaction is occurring. Advantageously, embodiments of the disclosure help to prevent potential victims from becoming actual victims by preventing them from falling into traps laid by fraudsters.

In one or more embodiments, a method in an electronic device comprises receiving, by a communication device of the electronic device, first electronic signals defining a financial transaction occurrence communication indicating that a financial transaction has occurred in a financial account of an authorized user of the electronic device. In one or more embodiments, the communication device also receives second electronic signals defining a financial transaction reversal request requesting that the financial transaction be reversed.

In one or more embodiments, a user interface of the electronic device detects user input initiating another financial transaction reversing the financial transaction in response to the financial transaction reversal request. In one or more embodiments, in response to receiving the first electronic signals, the second electronic signals (optionally within a predefined time duration from the first electronic signals), and the user input in response to the financial transaction reversal request, one or more processors of the electronic device present, using the user interface of the electronic device, a prompt comprising a fraud warning indicating that the financial transaction reversal request is likely fraudulent. In one or more embodiments, the one or more processors then prevent the other financial transaction after presenting the prompt.

In one or more embodiments, if the authorized user of the electronic device overrides the fraud warning, the one or more processors can complete the other financial transaction. However, if the authorized user attempts to capture a screenshot of the other financial transaction, in one or more embodiments the one or more processors can obscure at least some information, e.g., bank account number, account holder name, etc., depicted in the screen shot. Advantageously, embodiments of the disclosure prevent fraudulent activity from being completed in the commission of a crime.

Other steps can be performed as well. Illustrating by example, in one or more embodiments when first electronic signals are received delivering an indication that a financial transaction has occurred in a financial account of an authorized user of an electronic device and second electronic signals requesting that the financial transaction be reversed are received within a predefined time duration, one or more processors of the electronic device extract the telephone number from which the request to reverse was received and/or the account information to which the request to reverse is directed for validation in a fraud account checking process. From these results, the one or more processors can optionally present a history of fraudulent transactions associated with any account deemed to be suspicious.

In one or more embodiments, information associated with financial transactions that are likely fraudulent can be stored in a functional database. In one or more embodiments, if a sufficient number of verified electronic device users trigger the same fraud warning, this backend system managing the functional database can use machine learning to avoid providing such fraud warning or reduce the intensity level of the fraud warning to a basic warning. In one or more embodiments, the backend can increase the severity of the alert in detection of additional information requested by the authorized user of the electronic device such as a screenshot of the stranger as it will have personal and sensitive information. As noted above, in one or more embodiments the one or more processors of the electronic device—or the backend—can mask or filter sensitive information to further protect user data in the event an authorized user of an electronic device attempts to share a screenshot.

Other advantages offered by embodiments of the disclosure will be described below. Still others will be obvious to those of ordinary skill in the art having the benefit of this disclosure.

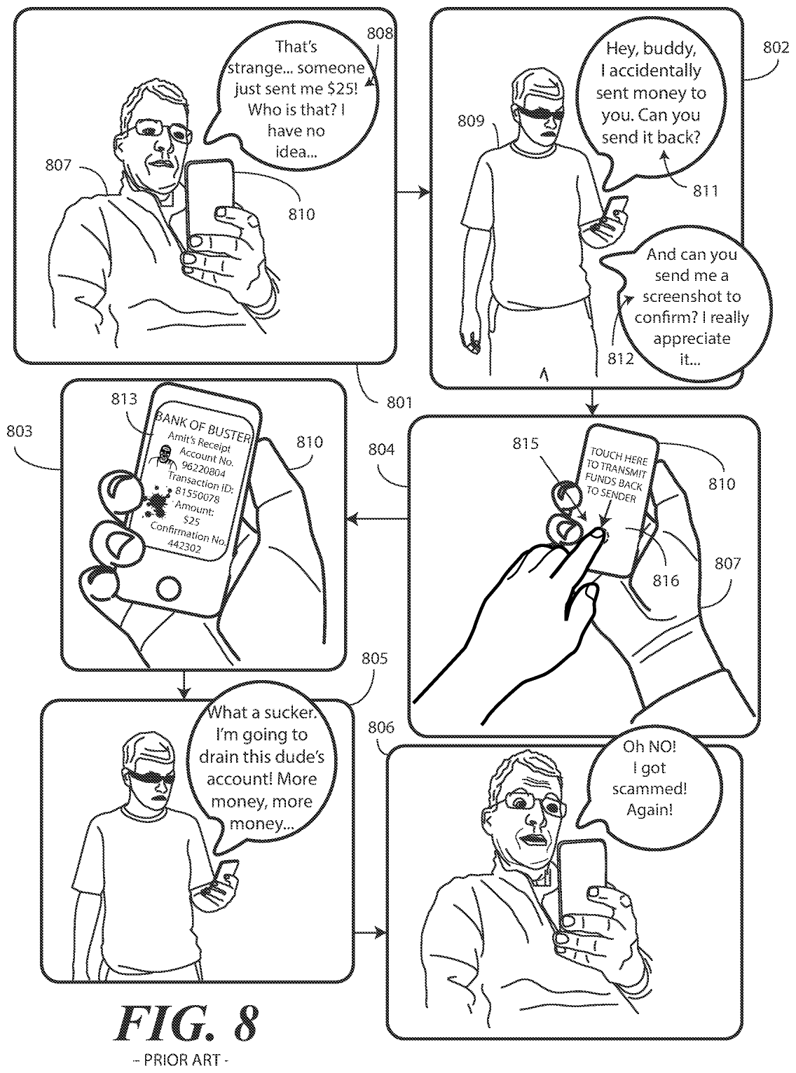

Turning first to FIG. 8, illustrated therein are one or more method steps illustrating how fraud can occur in prior art systems, using prior art devices and methods. Beginning at step 801, the target 807 of a scam is looking at his electronic device 810 and sees that he has received a mysterious financial transaction 808 for twenty-five dollars. Unable to determine where the money came from or why it was sent, the target 807 states, “That's strange . . . someone just sent me twenty-five dollars! Who is that? I have no idea . . . ”

As shown at step 802, it was a fraudster 809. The fraudster 809 immediately calls the target with a request to reverse 811. In addition to making the request to reverse 811, the fraudster 809 also makes a screenshot request 812 for confirmation. Unbeknownst to the target 807, this is all part of a giant scam.

At step 803, the target 807, being a good and decent person, complies with the request to reverse 811. As shown, the target captures a screenshot 813 from the Bank of Buster confirming the twenty-five-dollar financial transaction reversing the mysterious financial transaction 808. The screenshot 813 includes the target's bank account number, name, and other personal and financial information. At step 804, the target 807 delivers user input 815 to the user interface 816 of the electronic device 810 initiating the financial transaction reversing the mysterious financial transaction 808.

At step 805, the fraudster 809 now has all the information to hack the target's bank account. Laughing fiendishly, the fraudster 809 says, “What a sucker. I'm going to drain this dude's account.” Paraphrasing the iconic Marc Springer of Snortn' Boar Transport, the fraudster starts saying, “More money, more money, more money!” As shown at step 806, the poor target 807 now understands he has been scammed. Downtrodden and depressed, he laments all the work that must be done to try and get his precious money back.

Sadly, situations such as this are all too common. Fortunately, embodiments of the disclosure provide a solution to these problems. In one or more embodiments, a method in an electronic device comprises receiving, by a communication device of the electronic device, first electronic signals defining a financial transaction occurrence communication indicating that a financial transaction has occurred in a financial account of an authorized user of the electronic device and second electronic signals (optionally within a predefined time duration from the first electronic signals) defining a financial transaction reversal request requesting that the initial financial transaction be reversed.

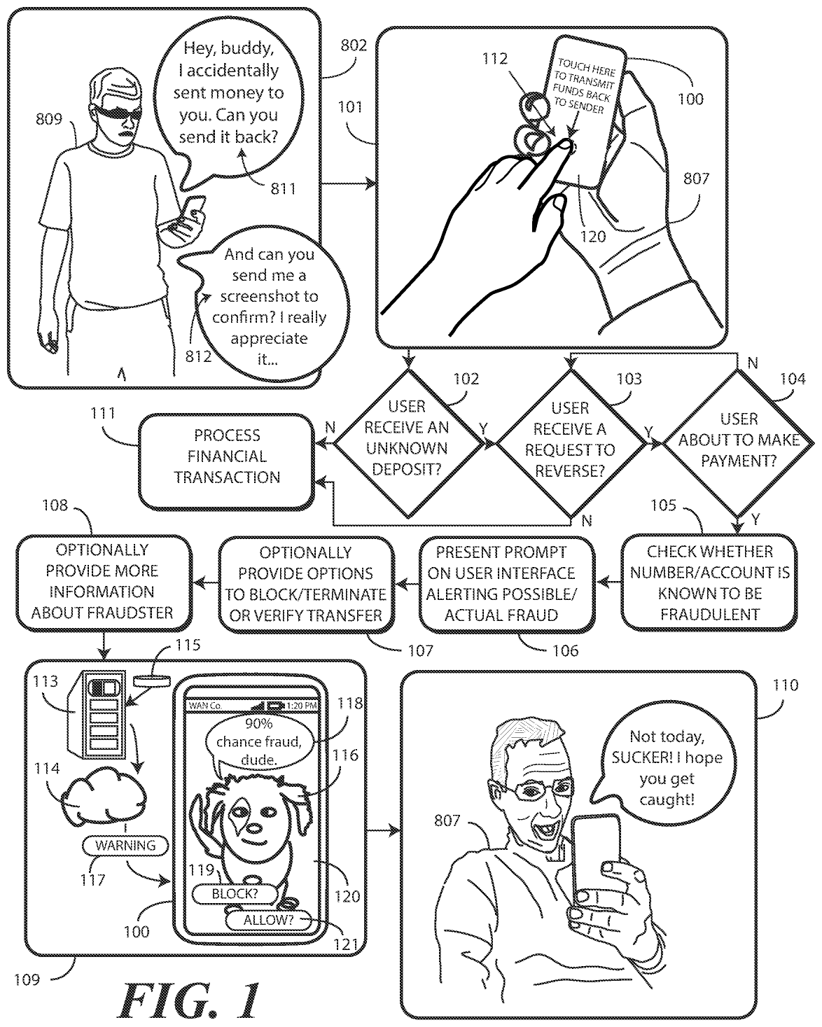

In one or more embodiments, when user input initiating another financial transaction reversing the financial transaction in response to the financial transaction reversal request is detected, one or more processors of the electronic device use the user interface to present a prompt comprising a fraud warning indicating that the financial transaction reversal request is likely fraudulent. Turning now to FIG. 1, illustrated therein are one or more method steps depicting how the dreadful situation illustrated in FIG. 8 can be avoided using embodiments of the disclosure.

FIG. 1 begins with step 802 of FIG. 8. As shown at step 802 the fraudster 809 immediately calls the target 807 after making a financial transaction (808) into a financial account belonging to the target 807 with a request to reverse 811. In addition to making the request to reverse 811, the fraudster 809 also makes a screenshot request 812 for confirmation. Once again, unbeknownst to the target 807 this is all part of a giant scam.

Fortunately for the target 807, in FIG. 1 he is using an electronic device 100 configured in accordance with one or more embodiments of the disclosure. The electronic device 100 comprises a communication device, a user interface (shown as a touch-sensitive display at step 101), and one or more processors operable with the user interface and communication device.

At step 101, the target 807 delivers user input 112 to the user interface of the electronic device 100 initiating the financial transaction reversing the mysterious financial transaction (808). At decision 102, the one or more processors of the electronic device 100 determine whether the communication device has received first electronic signals delivering an indication that a financial transaction has occurred in a financial account of the target 807.

In this illustrative example, we know that the communication device has received such first electronic signals, just in the same way they were received at step (801) of FIG. 8. Had they not been received (optionally within a predefined time duration prior to the user input 112), the one or more processors of the electronic device 100 could process the financial transaction initiated by the user input 112 at step 111.

Decision 103 then determines whether second electronic signals are received by the communication device that deliver a request to reverse 811 the mysterious financial transaction (808). Here, they have been, as the request to reverse 811 was delivered by the fraudster at step 802.

In one or more embodiments, decision 103 determines whether the communication device receives the second electronic signals delivering the request to reverse 811 the financial transaction are received within a predefined time duration of the first electronic signals delivering the indication that the mysterious financial transaction (808) was received. Embodiments of the disclosure contemplate that this particular scam typically includes a tightly time-coupled mysterious financial transaction (808) and request to reverse 811. Accordingly, in one or more embodiments decision 103 determines whether the second electronic signals are received within a predefined time duration after the first electronic signals are received. Where they are not, or otherwise where no such second electronic signals are received, the one or more processors of the electronic device 100 could process the financial transaction initiated by the user input 112 at step 111.

Embodiments of the disclosure also contemplate that it may be challenging for the fraudster 809 to hack the financial account of the target 807 solely by receiving a financial transaction reversing the mysterious financial transaction (808). In most cases, additional information is required. Accordingly, in most instances the fraudster 809 will include a screenshot request (812) for a screenshot (813) that includes some financial details regarding the financial account of the target 807, financial details of the financial transaction reversing the mysterious financial transaction (808), personal information about the target 807, information about the bank in which the financial account resides, or combinations thereof. Accordingly, in one or more embodiments decision 103 determines whether a screenshot request (812) for a screenshot (813) of a completion of the reversal of the mysterious financial transaction (808) is received. Such is the case in this illustrative example.

Decision 104 determines, using a user interface of the electronic device 100, whether user input 112 initiating another financial transaction reversing the mysterious financial transaction (808) is received. In this illustrative example, it is. Otherwise the method returns to decision 103 in a waiting mode of operation.

At optional step 105, a server complex 113 can be queried across a network 114 to determine if an account number and an electronic device identifier defined by the request to reverse 811 are associated with fraudulent activity. Illustrating by example, in one or more embodiments when first electronic signals are received delivering an indication that a mysterious financial transaction (808) has occurred in a financial account of an authorized user of an electronic device 100, as determined by decision 102, and second electronic signals requesting that the financial transaction be reversed are received, as determined by decision 103 and optionally within a predefined time duration, at step 105 one or more processors of the electronic device 100 extract electronic device identifier or account identifiers associated with the request to reverse 811.

Examples of account identifiers can include an account number, a combined account number and routing number, an account number and a SWIFT code, or other indicia allowing funds to be directed to a financial account. Other examples of such account identifiers will be obvious to those of ordinary skill in the art having the benefit of this disclosure.

As with the account identifier, the electronic device identifier can take a variety of forms. In a simple embodiment, the electronic device identifier can simply be Amit's phone number. However, since phone numbers can be easily transferred between devices, such as by switching a subscriber interface module (SIM) card, the electronic device identifier can take other forms as well. In other embodiments, the electronic device identifier is an anonymous string of numbers and letters that uniquely identifies a mobile device. In other embodiments, the electronic device identifier can be the identifier for advertisers (IDFA) promulgated by Apple.sup.™, the advertising identifier promulgated by Google.sup.™, the international mobile equipment identity (IMEI), a device serial number, or a secure identifier generated by a unique token that identifies an electronic device. Other examples of electronic device identifiers will be obvious to those of ordinary skill in the art having the benefit of this disclosure.

In one or more embodiments, the one or more processors extract the telephone number as the electronic device identifier from which the request to reverse 811 was received and/or the account information to which the request to reverse 811 is directed for validation in a fraud account checking process. From these results, the one or more processors can query the functional database of the server complex 113 across the network 114 to determine if the account number and the electronic device identifier defined by the request to reverse 811 are associated with fraudulent activity.

In this example the request to reverse 811 stems from an electronic communication (the fraudster's phone call) received by the electronic device 100 with the inbound call's telephone number serving as the electronic device identifier. While the telephone number is being used as the electronic device identifier in this example, during this phone call the electronic device 100 could identify the fraudster's device using any of the electronic device identifiers referenced above or others that will be obvious to those of ordinary skill in the art having the benefit of this disclosure in other embodiments.

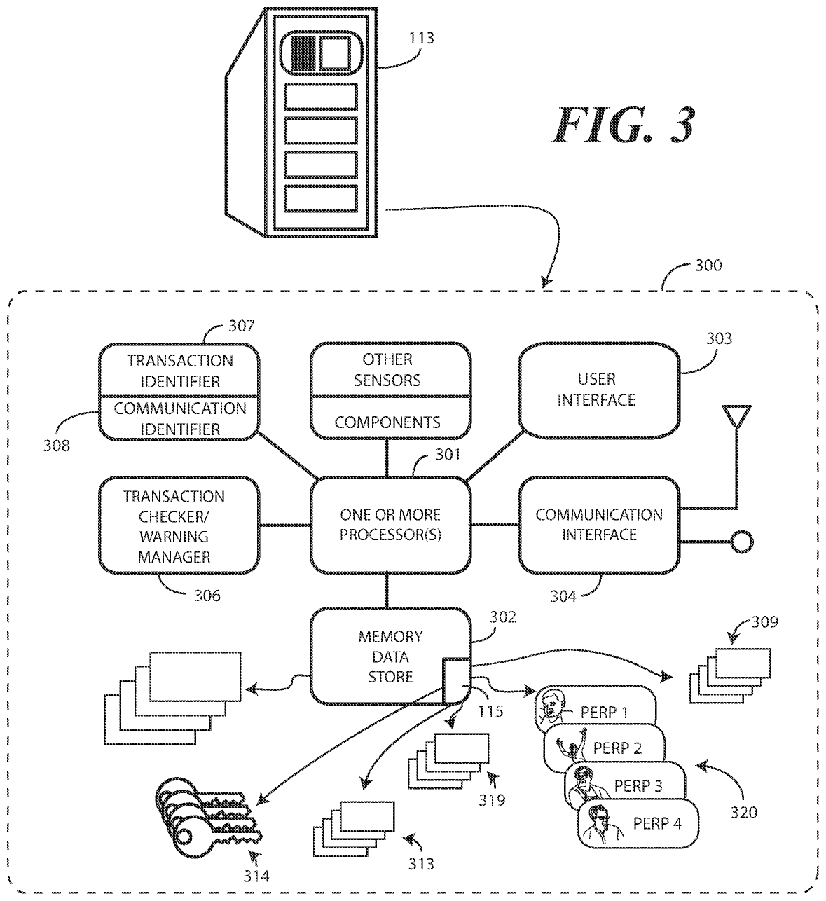

As will be described in more detail below with reference to FIG. 3, in one or more embodiments the electronic device 100 has access to a functional database 115. Accordingly, the optional querying occurring at step 105 can comprise utilizing this functional database 115 to determine whether the electronic device identifier has been associated with past fraudulent activity.

In one or more embodiments, the functional database 115 compiles at least a first set of electronic device identifiers associated with falsified account or personal identification numbers, a second set of electronic device identifiers having associated therewith reports of fraudulent activity, optionally in numbers exceeding a predefined report threshold, and a third set of electronic device identifiers verified as being associated with fraud by a third party. At step 105, the one or more processors of the electronic device 100 can optionally query the functional database 115 to determine whether the electronic device identifier is found in the first set of electronic device identifiers, the second set of electronic device identifiers, or the third set of electronic device identifiers.

In other embodiments, the functional database 115 can also include phone numbers associated with fake Social Security numbers or Primary Account Numbers from authorized government agencies. In one or more embodiments, the functional database 115 also includes phone numbers of criminals determined from authorized government agencies, examples of which include police databases and court databases.

In still other embodiments, the one or more processors of the electronic device 100 determines at step 105 that an account associated with the request to reverse 811 the mysterious financial transaction (808) is associated with possible fraudulent activity by comparing the account to the functional database 115, which includes one or more of: phone numbers that are marked as “spam” or marked as “junk” by all mobile users receiving incoming calls from an unknown number. Such spam or junk or fraud phone numbers can be identified in one or more embodiments by authorized third-party service providers, examples of which include TrueCaller.sup.™, WhatsApp.sup.™, GoogleCaller.sup.™, and others.

In one or more embodiments, the one or more processors of the electronic device 100 categorize an account as being associated with fraudulent activity based upon reports by verified users with fraudster bank account details after the verified users made a transaction to a fraudster account by getting duped. In one or more embodiments, such reports are considered verified when a threshold number of such reports are received. Thus, at optional step 105 one or more processors of the electronic device 100 query an account identifier associated with the request to reverse 811 to determine if the account to which the reversing financial transaction would be directed is associated with fraudulent activity. As described above, this step 105 can be done in a variety of ways.

At step 106, the one or more processors of the electronic device 100 use the user interface of the electronic device to present a prompt 116 comprising a fraud warning 117 indicating that the request to reverse 811 is likely fraudulent. Here, the prompt 116 includes a warning 117 of fraudulent activity.

In this illustrative example, the warning 117 includes a warning level 118 based upon a fraud ranking. Here the warning level 118 indicates that there is a ninety-percent chance that the request to reverse 811 is associated with fraudulent activity since there is off that chance that the request to reverse 811 did not come from a scammer. In one or more embodiments, the warning 117 identifies whether the electronic device identifier was found in the first set of electronic device identifiers, the second set of electronic device identifiers, or the third set of the electronic device identifiers of the functional database 115.

In this illustrative embodiment, step 107 comprises including a user actuation target 119 in the prompt 116 allowing the electronic financial transaction initiated by the target 807 via the user input 112 delivered at step 101 to be terminated. In one or more embodiments, when the target 807 actuates the user actuation target 119, the one or more processors of electronic device 100 cause the electronic financial transaction initiated at step 101 to be terminated. In this illustrative embodiment, the prompt 116 also includes another user actuation target 121 allowing the target 807 to override the warning 117 and complete the electronic financial transaction initiated at step 101.

Fortunately, here the one or more processors of electronic device 100 cause presentation of the prompt 116 before the electronic financial transaction initiated at step 101 is completed. Accordingly, the target 807 immediately actuates the user actuation target 119 provided by the prompt 116 to terminate the electronic financial transaction initiated at step 101. The one or more processors of the electronic device 100 then terminate the electronic financial transaction in response to this user input occurring at the user interface 120 of the electronic device 100.

As shown at step 110, the target 807 is elated. He exclaims, “Not today, sucker! I hope you get caught.” After successfully thwarting the fraud using embodiments of the disclosure, he decides to treat himself to a delicious “filter coffee,” which is one fifth coffee and four fifth's milk—simple, but delicious.

Other steps can optionally be performed in addition to the presentation of the prompt 116. Illustrating by example, optional step 108 can provide additional details about the fraudster 809 and/or past fraudulent activity. Step 108 can comprise optionally presenting a history of fraudulent transactions associated with any account deemed to be suspicious.

Since information associated with financial transactions that are likely fraudulent can be stored in a functional database 115, in one or more embodiments where a sufficient number of verified electronic device users trigger the same fraud warning 117, this backend system defined by the server complex 113 managing the functional database 115 can use machine learning to avoid providing such fraud warnings or reduce the warning level 118 of the fraud warning 117 to a basic warning at step 108. In one or more embodiments, step 108 can comprise the server complex 113 increasing the warning level 118 of the fraud warning 117 in detection of additional information requested by the target 807 such as a screenshot of the stranger as it will have personal and sensitive information.

If the transaction is completed at step 111, in one or more embodiments this step 111 comprises masking or filtering sensitive information to further protect user data in the event an authorized user of an electronic device attempts to share a screenshot. Illustrating by example, in one or more embodiments step 111 comprises obscuring at least some information captured in the screenshot.

Thus, as illustrated and described a method in an electronic device 100 comprises receiving, as determined by decision 102, first electronic signals defining a financial transaction occurrence communication indicating that a mysterious financial transaction (808) has occurred in a financial account of an authorized user of the electronic device 100. The method also comprises receiving, as determined by decision 103 and optionally within a predefined time duration from the first electronic signals, second electronic signals defining a financial transaction reversal request requesting that the financial transaction be reversed.

In one or more embodiments, the method detects, as determined by decision 104, a user interface 120 of the electronic device 100 receiving user input 112 initiating another financial transaction reversing the mysterious financial transaction (808) in response to the financial transaction reversal request detected at decision 103. In one or more embodiments, in response to receiving the first electronic signals, the second electronic signals (optionally within the predefined time duration from the first electronic signals, and the user input 112 in response to the financial transaction reversal request, one or more processors of the electronic device 100 present, at step 106, a prompt 116 comprising a fraud warning 117 indicating that the financial transaction reversal request is likely fraudulent.

Where a screenshot request 812 is received with the financial transaction reversal request, and where the target 807 captures such a screenshot (813), if the fraud warning 117 is overridden using user actuation target 121, step 111 can comprise obscuring at least some information depicted in the screenshot (813). By contrast, where user actuation target 119 is actuated, step 107 can comprise preventing the financial transaction initiated at step 101.

In one or more embodiments, presentation of the prompt 116 shown at step 109 only occurs when the second electronic signals are received within a predefined time duration after the first electronic signals are received. In one or more embodiments, presentation of the prompt 116 at step 106 only occurs when the second electronic signals also deliver the screenshot request 812 for the screenshot (813) depicting a completion of reversal of the mysterious financial transaction (808). In one or more embodiments, presentation of the prompt 116 at step 106 only occurs when user input 112 is received by a user interface 120 of the electronic device 100 requesting initiation of reversal of the mysterious financial transaction (808).

Where step 105 is included and the one or more processors of the electronic device 100 query the functional database 115 of the server complex 113 across the network 114 to determine if an account number and/or electronic device identifier of the fraudster's device defined by the request to reverse 811 are associated with fraudulent activity, and that querying results in determining the account number and/or electronic device identifier of the fraudster's device are associated with fraudulent activity, the warning level 118 of the prompt 116 can be increased in one or more embodiments. Additionally, where this occurs step 108 can comprise presenting details of the fraudulent activity.

At optional step 108, the functional database 115 can be updated with the fact that the target 807 has terminated an electronic financial transaction using the prompt 116 due to the fact that the account identifier associated with the account of the financial transaction was being used for fraudulent activity. This allows the functional database 115 to be continually updated with relevant information that can be used to stop the completion of financial transactions that are initiated by financial transaction initiation communications.

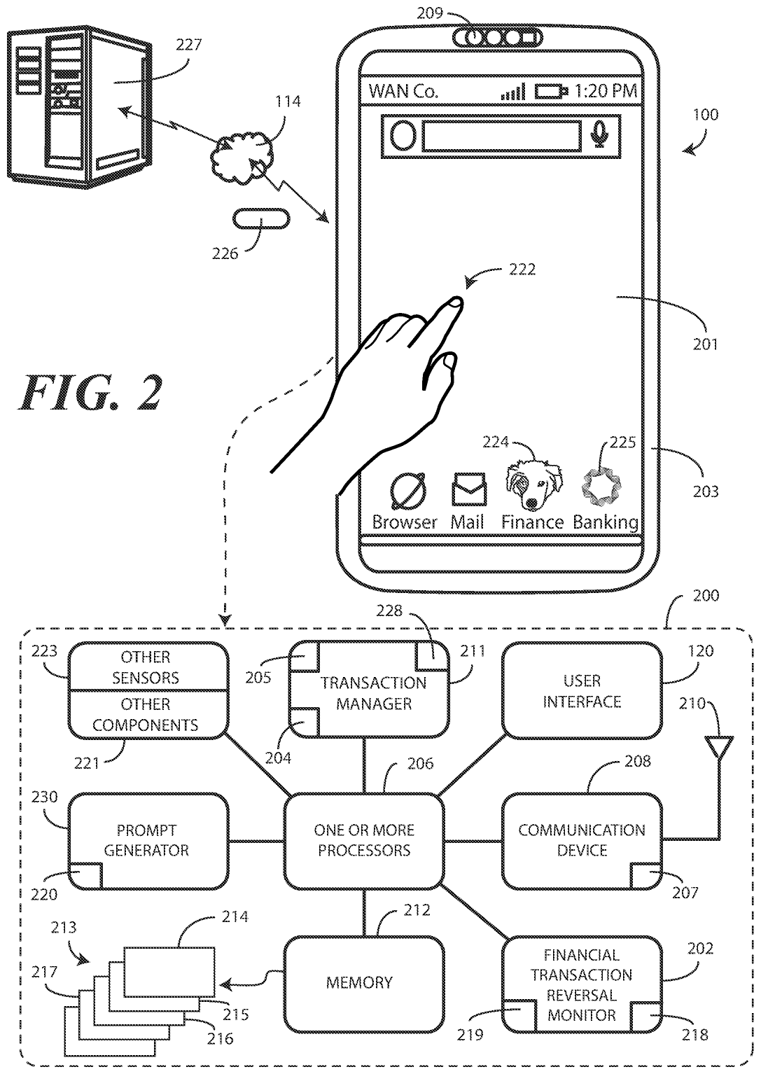

Turning now to FIG. 2, illustrated therein is one electronic device 100 configured in accordance with one or more embodiments of the disclosure. The electronic device 100 of this illustrative embodiment includes a user interface 120. In one or more embodiments, the user interface 120 comprises a display 201, which may optionally be touch-sensitive. The display 201 can serve as a primary user interface 120 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more financial applications 224 and/or banking applications 225 that allow financial transactions to be made using the electronic device 100.

Illustrating by example, in one or more embodiments a user can deliver user input to a financial application 224 or a banking application 225 to initiate a financial transaction initiation communication 204. In one or more embodiments, when this occurs the communication device 208 transmits a financial transaction initiation communication 204 generated by a transaction manager 211. In one or more embodiments, the financial transaction initiation communication 204 comprises an electronic device identifier from which a financial transaction initiation request was received by the communication device 208. When the financial transaction initiation request includes an account identifier 205, the transaction manager 211 can extract this account identifier 205 from the financial transaction initiation request and include it with the financial transaction initiation communication 204.

In one or more embodiments, the one or more processors 206 are responsible for managing the applications and all personal information received from the user interface 120 that is to be used by the finance application 224 and/or banking application 225 after the electronic device 100 is authenticated as a secure electronic device and the user identification credentials have triggered a login event. The one or more processors 206 can also be responsible for launching, monitoring and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the finance application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 223, which may include key selection sensors, touch pad sensors, capacitive sensors, motion sensors, and switches. Similarly, the other components 221 can include video, audio, and/or mechanical outputs.

The one or more sensors 223 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the electronic device 100 includes a financial transaction reversal monitor 202 and a prompt generator 230. In one or more embodiments, the financial transaction reversal monitor 202 and a prompt generator 230 can be operable with one or more processors 206, configured as a component of the one or more processors 206, or configured as one or more executable code modules operating on the one or more processors 206. In other embodiments, the financial transaction reversal monitor 202 and a prompt generator 230 can be standalone hardware components operating executable code or firmware to perform their functions. Other configurations for the financial transaction reversal monitor 202 and a prompt generator 230 will be obvious to those of ordinary skill in the art having the benefit of this disclosure.

In one or more embodiments, the financial transaction reversal monitor 202 is configured to detect request to reverse triggers associated with a financial transaction. Illustrating by example, in one or more embodiments the financial transaction reversal monitor 202 is operable to detect when the communication device 208 receives a financial transaction communication 218 followed by a financial transaction reversal request communication 219. In one or more embodiments, the financial transaction reversal monitor 202 is operable to detect when the communication device 208 receives a financial transaction communication 218 followed by a financial transaction reversal request communication 219 within a predefined time duration.

Illustrating by example, if a scammer transmits a nominal sum to the financial account of an authorized user of the electronic device 100, the financial institution will send a notification of this financial transaction to the electronic device 100 in the form of a financial transaction communication 218. If the scammer then calls, texts, emails, or otherwise communicates with the authorized user of the electronic device 100 via the electronic device to ask for the nominal sum back, this occurs in the form of a financial transaction reversal request communication 219.

In one or more embodiments, when the financial transaction reversal monitor 202 detects the financial transaction communication 218 and the financial transaction reversal request communication 219, optionally within a predefined time duration, the financial transaction reversal monitor 202 triggers prompt generator 230. In one or more embodiments, the prompt generator 230 then causes the user interface 120 to deliver a prompt 220 comprising a fraud warning indicating that the financial transaction reversal request is likely fraudulent.

In one or more embodiments, the prompt 220 comprises an audible prompt. In other embodiments, the prompt 220 comprises a visual presentation presented on the display 201. An example of such a prompt (116) was illustrated above with reference to FIG. 1.

In one or more embodiments, the prompt generator 230 causes the user interface 120 to deliver the prompt only when user input 222 is received at the user interface 120 initiating another financial transaction reversing the financial transaction identified by the financial transaction communication 218 in response to the financial transaction reversal request identified by the financial transaction reversal request communication 219.

As previously described above with reference to FIG. 1, in one or more embodiments the prompt 220 comprises a user actuation target (examples of user actuation targets are shown in FIG. 2 with reference to the finance application 224 and the banking application 225) that, when actuated, causes the communication device 208 to transmit a financial transaction reversal communication 226 to a remote electronic device 227 across a network 114.

As noted above, many a scammer employing the “request to reverse” scam will also ask for a screenshot (one example of which was shown as screenshot 813 in FIG. 8), receipt, email, or other communication 228 verifying that the reversing financial transaction has been completed. In one or more embodiments, when the user interface 120 receives user input 222 request that the communication device 208 transmit a screenshot (813) or equivalent communication 228 of the reversing financial transaction to another remote electronic device (like that of the fraudster (809) shown at step (802) of FIG. 1), the financial transaction reversal monitor 202 can obscure one or more portions of the screenshot (813) or equivalent communication 228 prior to the communication device 208 transmitting the same. Illustrating by example, using the screenshot (813) of FIG. 8, the financial transaction reversal monitor 202 may obscure the bank name, the account holder's name, and the account number from which the reversing financial transaction was sent. Other portions to obscure will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

Turning now to FIG. 3, illustrated therein is one explanatory server complex 113 with which the electronic device (100) of FIG. 2 may communicate across a network (114). The server complex 113 is illustrated as a cloud server in FIG. 3. However, in other embodiments, the remote electronic device can be another type of computer, server, a server complex, network hub, or other computing device configured to authenticate one or more electronic devices as secure or trusted electronic devices.

An illustrative schematic block diagram 300 is also shown in FIG. 3. As with the block diagram schematic of FIG. 2, it is to be understood that the schematic block diagram 300 of FIG. 3 is provided for illustrative purposes only and for illustrating components of one explanatory cloud server configured in accordance with one or more embodiments of the disclosure. Accordingly, the components shown in either FIG. 2 or FIG. 3 are not intended to be complete schematic diagrams of the various components required for a particular device, as other devices configured in accordance with embodiments of the disclosure may include various other components not shown in FIG. 2 or FIG. 3. Alternatively, other remote electronic devices configured in accordance with embodiments of the disclosure or may include a combination of two or more components or a division of a particular component into two or more separate components, and still be within the scope of the present disclosure.

In one or more embodiments, the server complex 113 includes one or more processors 301, one or more memory devices 302, and one or more user interface devices 303, e.g., a display, a keyboard, a mouse, audio input devices, audio output devices, and alternate visual output devices. The server complex 113 also includes a communication device 304. These components can be operatively coupled together such that, for example, the one or more processors 301 are operable with the one or more memory devices 302, the one or more user interface devices 303, and/or the communication device 304 in one or more embodiments.

The one or more processors 301 can include a microprocessor, a group of processing components, one or more ASICs, programmable logic, or other type of processing device. The one or more processors 301 can be configured to process and execute executable software code to perform the various functions of the server complex 113.

The one or more memory devices 302 can optionally store the executable software code used by the one or more processors 301 in carrying out the operations of authenticating electronic devices as secure or trusted electronic devices. The one or more memory devices 302 may include either or both of static and dynamic memory components, as well as one or more encrypted memory devices 302. The one or more memory devices 302 can store both embedded software code and user data. The software code can embody program instructions and methods to operate the various functions of the terminal device, and also to execute software or firmware applications and modules such as the user identification engine 307, the user transaction engine 308, and the transaction warning manager 306.

In one or more embodiments, the communication device 304 comprises any of a number of wired or wireless technologies for communication. Examples of these technologies include wired plain old telephone service (POTS) technologies, wired Ethernet technologies such as those configured in accordance with the IEEE 802.11 networking standards, peer-to-peer or ad hoc communications, frequency modulated communication, amplitude modulated communication, or IEEE 802.11 wireless communication. Other forms of communication technologies suitable for inclusion with the communication device 304 will be obvious to those having the benefit of this disclosure. The communication device 304 can include wired or wireless communication circuitry, one of a receiver, a transmitter, or transceiver. Where wireless, the communication device 304 can include one or more antennas.

In one or more embodiments, the communication device 304 is operable to establish electronic communication with an electronic device (100) across a network (114). In one or more embodiments, the communication device 304 is operable to receive a financial transaction initiation communication from at least one remote electronic device (100) comprising an electronic device identifier from which a financial transaction initiation request was received by the at least one remote electronic device (100). Thereafter the one or more processors 301 can determine whether the financial transaction initiation request was in response to a financial transaction reversal request communication to determine if fraudulent activity may be at play.

In one or more embodiments the cloud server can be configured for performing processor-intensive methods, operations, steps, functions, or procedures associated with receiving a financial transaction initiation communication in response to a financial transaction reversal request communication from at least one remote electronic device, e.g., electronic device (100), in communication with the communication device 304 of the server complex 113 across a network (114). In one or more embodiments, the one or more processors 301 of the server complex 113 can then query the one or more memory devices 302 to determine if the financial transaction reversal request communication was received from a fraudulent actor.

In one or more embodiments, the one or more processors 301 of the server complex 113 do this by querying, in response to the financial transaction initiation communication that is responsive to a financial transaction reversal request communication, a functional database 115. In one or more embodiments, the functional database 115 is a construction of at least a first set 309 of electronic device identifiers associated with falsified account or personal identification numbers, a second set 313 of electronic device identifiers having associated therewith reports of fraudulent activity, optionally in quantities exceeding a predefined report threshold, a third set 319 of electronic device identifier verified as being associated with fraud by a third party, and a fourth set 320 of electronic device identifiers associated with fraudulent perpetrators. In one or more embodiments, the electronic device identifiers stored in the functional database 115 are verified by a third-party source. In one or more embodiments, the functional database 115 also includes a set 314 of account identifiers of accounts associated with fraudulent activity as well.

In one or more embodiments, the one or more processors 301 use the functional database 115 to determine whether an electronic device identifier associated with the transmission of a financial transaction reversal request communication has been associated with past fraudulent activity. In one or more embodiments, a transaction warning manager 306 determines that the electronic device identifier has been associated with past fraudulent activity when a plurality of remote electronic device in communication with the server complex 113 having a quantity exceeding a predefined threshold has transmitted electronic communications to the communication device 304 indicating that the electronic device identifier in question is suspect of being used fraudulently.

In one or more embodiments, the transaction warning manager 306 determines that the electronic device identifier in question has been associated with the past fraudulent activity when another server complex that is in communication with the communication device 304, confirms that the electronic device identifier has been used fraudulently. In one or more embodiments, this server complex is a government operated server, examples of which include police databases and court databases. In still other embodiments, the transaction warning manager 306 determines that an electronic device identifier in question has been associated with the past fraudulent activity when the electronic device identifier is associated with a falsified account number or personal identification number found in the functional database 110.

In one or more embodiments when the communication device 304 receives a financial transaction initiation communication from at least one remote electronic device comprising an electronic device identifier from which a financial transaction reversal request communication was received, the transaction warning manager 306 determines whether the electronic device identifier is associated with an account identifier of an account used for fraud. This can be done by referencing the set 314 of account identifiers in the functional database 115 or the other data stored in the functional database 115 in one or more embodiments.

Illustrating by example, the transaction warning manager 306 can query the functional database 115 in response to either a financial transaction communication responding to a financial transaction reversal request communication or a financial transaction reversal request communication itself to determine whether the electronic device identifier from which the financial transaction reversal request communication was received is found in the first set 309 of electronic device identifiers, the second set 313 of electronic device identifiers, the third set 319 of electronic device identifiers, or the fourth set 320 of electronic device identifiers. When the electronic device identifier is found in one of these sets, the transaction warning manager 306 can cause the communication device 304 to present a prompt on the electronic device attempting to respond to the financial transaction reversal request communication warning of fraudulent activity.

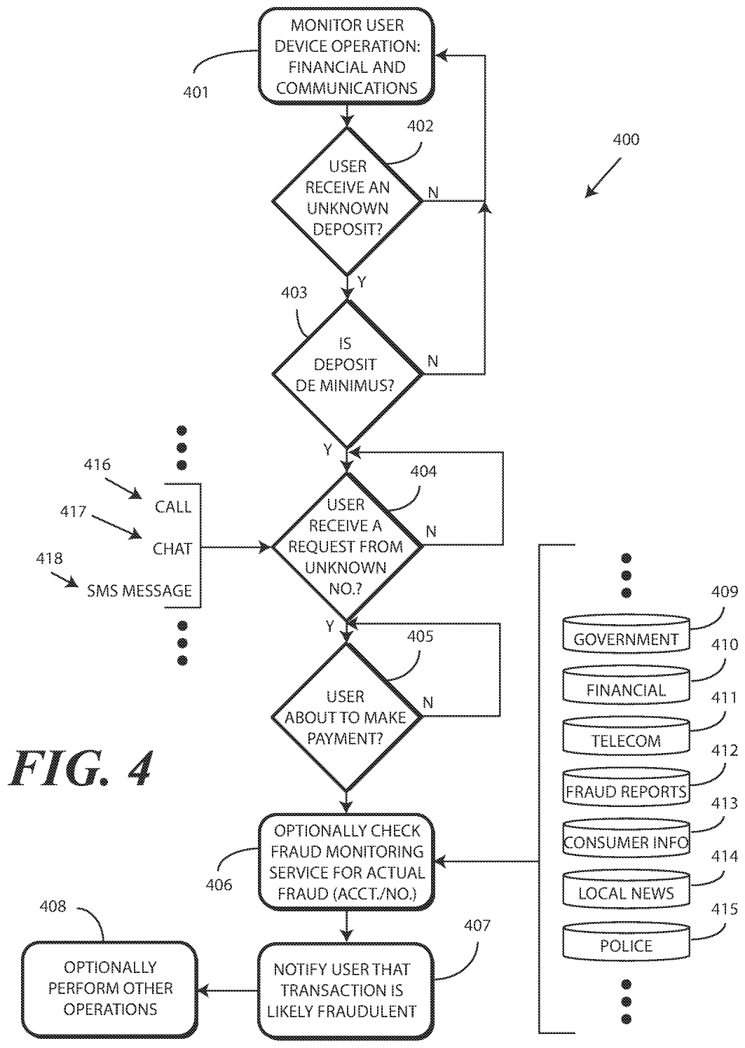

Turning now to FIG. 4, illustrated therein is one explanatory method 400 suitable for execution in an electronic device (100) or server complex (113) in accordance with one or more embodiments of the disclosure. The method 400 of FIG. 4 determines whether first electronic signals delivering in indication that a financial transaction has occurred in a financial account of an authorized user of the electronic device are received along with second electronic signals delivering a request that the financial transaction be reversed, optionally within a predefined time duration after the first electronic signals are received. Where this occurs, in one or more embodiments the method 400 causes the presentation of a prompt comprising a fraud warning indicating that the request to reverse the financial transaction is likely fraudulent. In one or more embodiments, the prompt is presented only after user input is received at a user input requesting the initiation of a reversal of the financial transaction.

Beginning at step 401, the method 400 monitors financial transaction communications occurring in an electronic device belonging to an authorized user of the electronic device. Decision 402 determines whether an unknown deposit is received in a financial account belonging to the authorized user of the electronic device. In one or more embodiments, this decision 402 is made when first electronic signals are received by a communication device of the electronic device that deliver an indication that a financial transaction has occurred in the financial account of the authorized user of the electronic device.

Optional decision 403 determines whether the financial transaction is small or de minims. Embodiments of the disclosure contemplate that fraudsters attempting to execute the “request to reverse” con typically transfer a small amount such as a recipient might be expected to receive if the sender was reimbursing the recipient for a meal or a movie ticket. Embodiments of the disclosure contemplate that it is unlikely that a fraudster would risk depositing large amounts of money in another person's account when executing the “request to reverse” scheme. Accordingly, optional decision 403 allows for a petty deposit dependency as an additional check to determine whether the initial financial transaction detected at decision 402 is likely fraudulent.

At decision 404, the method 400 checks to see if there is a request to reverse the financial transaction detected at decision 402. In one or more embodiments, this decision 404 is made when second electronic signals are received by a communication device of the electronic device that delivery a request that the financial transaction detected at decision 402 be reversed. These second electronic signals could be from an incoming phone call 416, a request to chat 417, a text message 418, or other communication vehicles. Other ways that second electronic signals delivering a request that the financial transaction detected at decision 402 be reversed will be obvious to those of ordinary skill in the art having the benefit of this disclosure.

Decision 405 determines if the authorized user of the electronic device is attempting to execute a reversal of the financial transaction. As noted above, the reversal could be a direct reversal or could be the initiation of another financial transaction to return the funds received in the financial transaction detected at decision 402. In one or more embodiments, decision 405 is made when user input is received at a user interface of the electronic device attempting an initiation of reversal of the financial transaction detected at decision 402.

At step 406, the method 400 determines whether the account to which the reversal financial transaction is directed or an electronic device identifier of an electronic device delivering the financial transaction reversal request communication is associated with fraud. In one or more embodiments, step 406 consults with one or more server complexes to make this determination.

Examples of such server complexes include government operated server complexes 409,415 that include reports of social security numbers being used fraudulently, police reports of crime, court reports of convictions, and so forth. They can include third party server complexes, including bank-operated server complexes 410 indicating that primary account numbers have been sued fraudulently, server complex complexes 411 indicating that electronic device identifiers have been fraudulently used, consumer information server complexes 413, user-initiated fraud report server complexes 412, and even local news server complexes 414 reporting financial crimes. This list is illustrative only, as other sources from which fraudulent activity can be detected will be obvious to those of ordinary skill in the art having the benefit of this disclosure.

The information stored in such sources can include confirmed fraud reports associated with the account or account identifier, reports of fraudulent activity exceeding a predefined threshold number, fake credentials associated with the account or account identifier, theft reports of electronic devices having the electronic device identifier associated with the financial transaction initiation request, or even location data associated with the electronic device having the electronic device identifier associated with the financial transaction initiation request.

Step 406 determines whether the account corresponding to the financial transaction reversal request communication is associated with fraudulent activity. This step 406 can include querying the account identifier to determine if the account is associated with fraudulent activity in one or more embodiments. This step 406 can also include querying one of the functional databases operating on the aforementioned server complexes as well.

When fraud is suspected, step 407 warns the user. This can include, if the account is associate with fraudulent activity, causing a fraud warning to be presented on a user interface of the electronic device initiating the financial transaction. In one or more embodiments, step 407 causes the presentation of a prompt comprising a fraud warning indicating that the request to reverse the financial transaction detected at decision 402 is likely fraudulent.

In one or more embodiments, the prompt presented at step 407 is presented only when the second electronic signals delivering the request that the financial transaction detected at decision 402 be reversed are received within a predefined time duration after the first electronic signals delivering the indication that the financial transaction has occurred are received. In one or more embodiments, the presentation of the prompt at step 407 only occurs when the second electronic signals delivering the request to reverse the financial transaction detected at decision 402 includes a request for a screenshot of a completion of the reversal of the financial transaction. In one or more embodiments, the presentation of the prompt at step 407 occurs in response to the user input detected at decision 405 that was attempting to reverse the financial transaction.

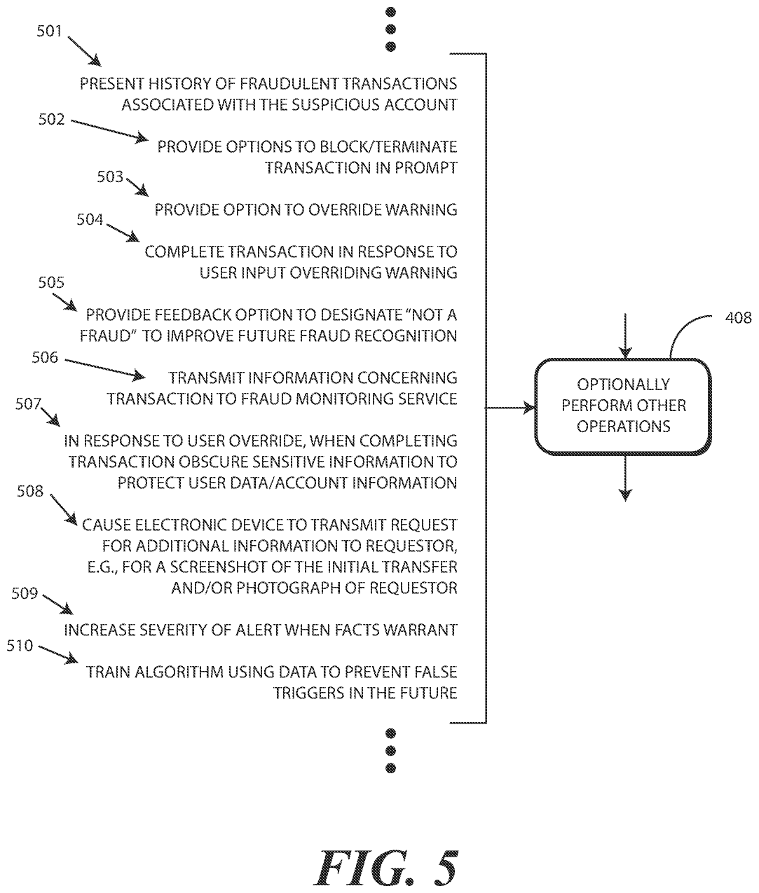

Optional step 408 can then perform other operations. Turning now to FIG. 5, illustrated therein are some examples of operations that can be performed at step 408.

These other operations can include presenting a history 501 of fraudulent transactions associated with the account to which the reversal of the financial transaction is to be directed. As noted above, options 502 to block or terminate the reversal of the financial transaction can be provided. Examples include providing a user actuation target in the prompt that, when actuated, causes the electronic device to prevent the reversal of the financial transaction.

Override options 503 can be provided to allow the prompt or fraud warning to be overridden. Illustrating by example, in one or more embodiments a user actuation target can be provided that allows an override 504 of the fraud warning. Where this is actuated, the electronic device can complete the financial transaction detected at decision (405) of the method (400) of FIG. 4. Said differently, when a user actuation target allowing an override of the prompt or fraud warning is actuated, a communication device of the electronic device can transmit a financial transaction reversal validation communication to a remote electronic device across a network to complete the financial transaction detected at decision (405) of the method (400) of FIG. 4.

In one or more embodiments, the other operations can include providing a feedback mechanism 505 allowing a user who knows that a financial transaction being initiated is not fraudulent. This may help the electronic device or a server complex with which the electronic device is in communication better detect fraudulent activity in the future. Information 506 concerning the fraudulent activity can be transmitted to a fraud monitoring service so that if a fraudster tries to commit the request to reverse scam in the future they will be caught and put in jail.

In many instances of the request to reverse scam, a screenshot indicating completion of a reversal financial transaction will be requested. Where this occurs, one or more portions 507 of the screenshot can be obscured prior to communication of the screenshot. Said differently, an operation that can be performed at step 408 comprises obscuring one or more portions 507 of the screenshot captured at a user interface verifying completion of a reversal of a financial transaction prior to transmitting the screenshot to a remote electronic device from which the financial transaction reversal request communication was received.

In some embodiments, additional information 508 from the source of the financial transaction reversal request communication can be requested. This additional information may include a picture of the person sending the financial transaction reversal request communication, a picture of a driver's license or other government identification of the person sending the financial transaction reversal request communication, or other information more particularly identifying the person sending the financial transaction reversal request communication.

The severity 509 of the fraud warning in the prompt can be increased or decreased based upon the facts of the situation. Of course, a backend system 510 can be trained from the facts at hand to improve future fraudulent activity warnings as well.

Other operations that can be performed at step 408 will be obvious to those of ordinary skill in the art having the benefit of this disclosure. Examples include providing more information about the fraudster, providing reasons for flagging the financial transaction reversal as fraudulent, providing details of previous fraudulent incidents, and other information.

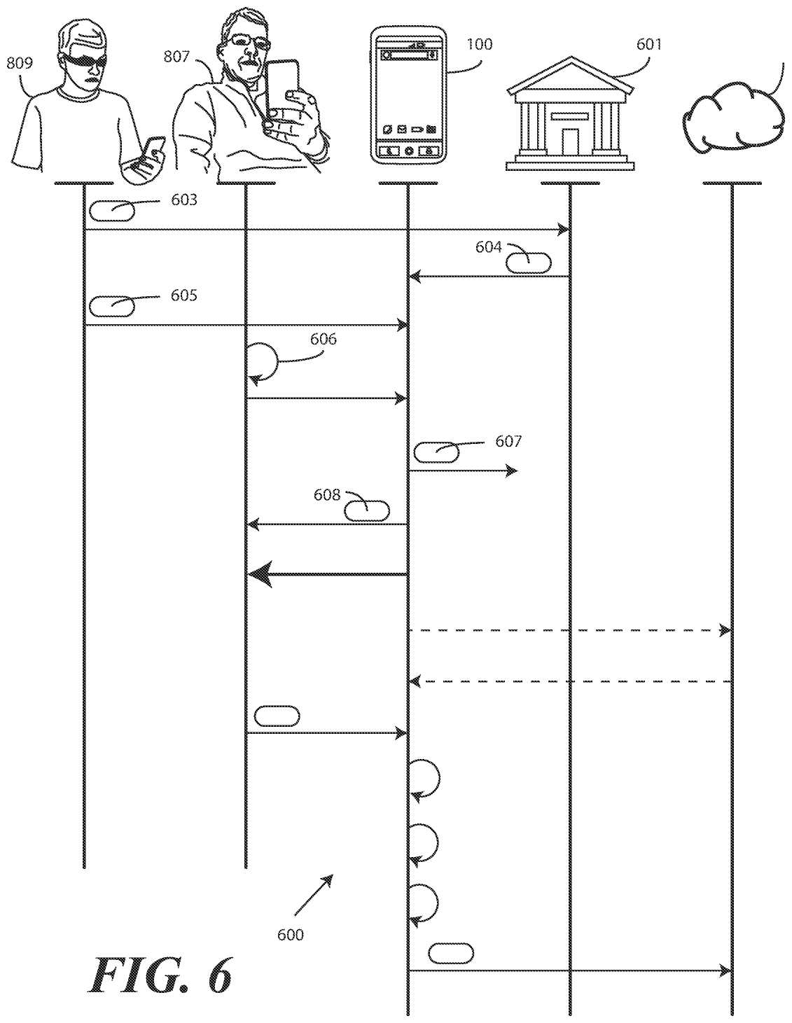

Turning now to FIG. 6, illustrated therein is one explanatory flow diagram 600 illustrating how methods in accordance with embodiments of the disclosure can be implemented. The flow diagram 600 performs fraud detection using a cloud server 602 in this illustration. However, the fraud detection could be performed in a user's electronic device 100 as well.

Initially, a fraudster 809 makes a small deposit 603 in a financial account 601 belonging to an authorized user of an electronic device 100, which in this example is target 807. When this occurs, the electronic device 100 receives, using a communication device, first electronic signals 604 defining a financial transaction communication indicating that the financial transaction associated with the small deposit 603 has occurred in the financial account 601 of the authorized user of the electronic device 100.

The communication device of the electronic device 100 also receives second electronic signals 605 from the electronic device belonging to the fraudster 809 within a predefined time duration from the first electronic signals 604 defining a financial transaction reversal request requesting that the financial transaction associated with the small deposit 603 be reversed.

A user interface of the electronic device 100 then detects user input 606 initiating another financial transaction 607 in response to the financial transaction reversal request defined by the second electronic signals 605. In one or more embodiments, when this occurs, i.e., in response to the first electronic signals 604, the second electronic signals 605, and the user input 606, one or more processors of the electronic device 100 present a prompt 608 comprising a fraud warning indicating that the financial transaction reversal request is likely fraudulent.

Other operations can be performed as well. These include receiving, at the user interface of the electronic device 100, an override of the fraud warning in the prompt 608 and completing the financial transaction 607 initiated by the authorized user of the electronic device 100. Additionally, these can include capturing a screen shot of the financial transaction 607 and obscuring at least some information depicted in the screenshot. These operations can also include preventing the financial transaction 607 after presenting the prompt.

Other operations will be obvious to those of ordinary skill in the art having the benefit of this disclosure. For instance, the electronic device 100 can query a functional database to determine whether an electronic device identifier identified by the financial transaction reversal request communication is associated with fraudulent activity as previously described.

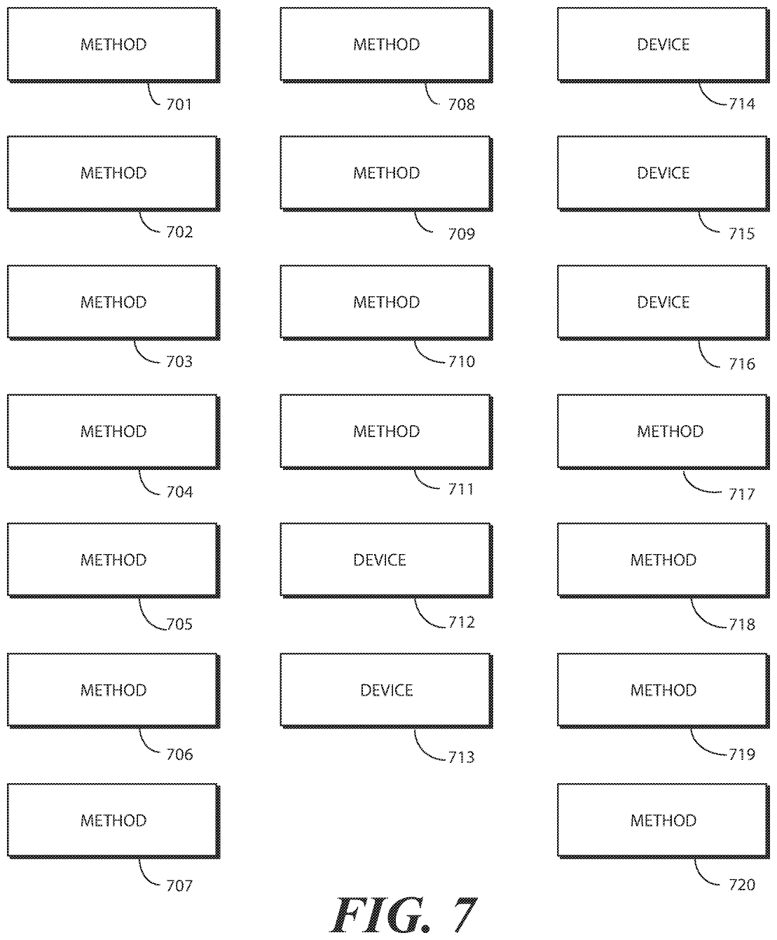

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises receiving, by a communication device, first electronic signals delivering an indication that a financial transaction has occurred in a financial account of an authorized user of the electronic device. At 701, the method comprises also receiving, by the communication device, second electronic signals delivering a request that the financial transaction be reversed.

At 701, in response to receiving the first electronic signals and the second electronic signals, the method comprises presenting, by one or more processors using a user interface of the electronic device, a prompt. At 701, the prompt comprises a fraud warning indicating that the request to reverse the financial transaction is likely fraudulent.

At 702, the presenting of the prompt comprising the fraud warning of 701 only occurs when the second electronic signals are received within a predetermined time duration after the first electronic signals are received. At 703, presenting of the prompt comprising the fraud warning of 701 only occurs when the second electronic signals also deliver a request for a screenshot of a completion of reversal of the financial transaction.

At 704, the method of 701 further comprises detecting, by the one or more processors from the user interface, user input requesting initiation of reversal of the financial transaction. At 704, the presenting the prompt comprising the fraud warning occurs in response to the user input.

At 705, the method of 701 further comprises querying, by the one or more processors, a server complex across a network to determine if an account number and an electronic device identifier defined by the request that the financial transaction be reversed are associated with fraudulent activity. At 706, when the querying of 705 results in determining that the account number and the electronic device identifier defined by the request that the financial transaction be reversed are associated with the fraudulent activity, the method further comprises increasing a severity level of the prompt. At 707, when the querying of 705 results in determining that the account number and the electronic device identifier defined by the request that the financial transaction be reversed are associated with the fraudulent activity, the method further comprises presenting details of the fraudulent activity.

At 708, the method of 705 further comprises transmitting details of the financial transaction to the server complex. At 709, the prompt of 701 comprises a user actuation target allowing the authorized user to override the prompt to complete reversal of the financial transaction.

At 710, in response to actuation of the user actuation target of 709, the method comprises obscuring, by the one or more processors, portions of a screenshot captured of the user interface verifying completion of reversal of the financial transaction and transmitting, by the communication device, the screenshot to a remote electronic device from which the second electronic signals were received. At 711, the prompt of 701 comprises a user actuation target allowing reversal of the financial transaction to be terminated.

At 712, an electronic device comprises a communication device and a user interface. At 712, the electronic device comprises one or more processors operable with the communication device and the user interface.

At 712, in response to the communication device receiving a financial transaction communication and a financial transaction reversal request communication within a predefined time duration threshold, the one or more processors cause the user interface to deliver a prompt comprising a fraud warning indicating that the financial transaction reversal request is likely fraudulent. At 713, the prompt of 712 comprises an audible prompt.

At 714, the one or more processors of 712 cause the user interface to deliver the prompt only when user input is received at the user interface initiating another financial transaction reversing the financial transaction in response to the financial transaction reversal request. At 715, the prompt of 714 comprises a user actuation target that, when actuated, causes the communication device to transmit a financial transaction reversal validation communication to a remote electronic device across a network. At 716, when the user interface of 715 receives user input requesting the communication device transmit a screenshot of the other financial transaction to another remote electronic device across the network, the one or more processors obscure one or more portions of the screenshot prior to the communication device transmitting the screenshot.

At 717, a method in an electronic device comprises receiving, by a communication device of the electronic device, first electronic signals defining a financial transaction occurrence communication indicating that a financial transaction has occurred in a financial account of an authorized user of the electronic device. At 717, the method comprises also receiving, by the communication device within a predefined time duration from the first electronic signals, second electronic signals defining a financial transaction reversal request requesting that the financial transaction be reversed.

At 717, the method comprises detecting, by a user interface of the electronic device, user input initiating another financial transaction reversing the financial transaction in response to the financial transaction reversal request. At 717, in response to receiving the first electronic signals, the second electronic signals within the predefined time duration from the first electronic signals, and the user input in response to the financial transaction reversal request, the method comprises presenting, by one or more processors using the user interface of the electronic device, a prompt comprising a fraud warning indicating that the financial transaction reversal request is likely fraudulent.

At 718, the method of 717 further comprises receiving, by the user interface, an override of the fraud warning and completing, by the one or more processors, the other financial transaction. At 719, the method of 717 further comprises capturing, by the one or more processors, a screenshot of a confirmation of the other financial transaction and obscuring at least some information depicted in the screenshot. At 720, the method of 717 further comprises preventing, by the one or more processors, the other financial transaction after presenting the prompt.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a communication device, first electronic signals delivering an indication that a financial transaction has occurred in a financial account of an authorized user of the electronic device;
also receiving, by the communication device, second electronic signals delivering a request that the financial transaction be reversed; and
in response to receiving the first electronic signals and the second electronic signals, presenting, by one or more processors using a user interface of the electronic device, a prompt comprising a fraud warning indicating that the request to reverse the financial transaction is likely fraudulent.

2. The method of claim 1, wherein the presenting the prompt comprising the fraud warning only occurs when the second electronic signals are received within a predetermined time duration after the first electronic signals are received.

3. The method of claim 1, wherein the presenting the prompt comprising the fraud warning only occurs when the second electronic signals also deliver a request for a screenshot of a completion of reversal of the financial transaction.

4. The method of claim 1, further comprising detecting, by the one or more processors from the user interface, user input requesting initiation of reversal of the financial transaction, wherein the presenting the prompt comprising the fraud warning occurs in response to the user input.

5. The method of claim 1, further comprising querying, by the one or more processors, a server complex across a network to determine if an account number and an electronic device identifier defined by the request that the financial transaction be reversed are associated with fraudulent activity.

6. The method of claim 5, wherein when the querying results in determining that the account number and the electronic device identifier defined by the request that the financial transaction be reversed are associated with the fraudulent activity, the method further comprises increasing a severity level of the prompt.

7. The method of claim 5, wherein when the querying results in determining that the account number and the electronic device identifier defined by the request that the financial transaction be reversed are associated with the fraudulent activity the method further comprises presenting details of the fraudulent activity.

8. The method of claim 5, further comprising transmitting details of the financial transaction to the server complex.

9. The method of claim 1, wherein the prompt comprises a user actuation target allowing the authorized user to override the prompt to complete reversal of the financial transaction.

10. The method of claim 9, further comprising, in response to actuation of the user actuation target:
obscuring, by the one or more processors, portions of a screenshot captured of the user interface verifying completion of reversal of the financial transaction; and
transmitting, by the communication device, the screenshot to a remote electronic device from which the second electronic signals were received.

11. The method of claim 1, wherein the prompt comprises a user actuation target allowing reversal of the financial transaction to be terminated.

12. An electronic device, comprising:
a communication device;
a user interface; and
one or more processors operable with the communication device and the user interface;
wherein, in response to the communication device receiving a financial transaction communication and a financial transaction reversal request communication within a predefined time duration threshold, the one or more processors cause the user interface to deliver a prompt comprising a fraud warning indicating that the financial transaction reversal request communication is likely fraudulent.

13. The electronic device of claim 12, wherein the prompt comprises an audible prompt.

14. The electronic device of claim 12, wherein the one or more processors cause the user interface to deliver the prompt only when the financial transaction communication is received from an unknown remote electronic device.

15. The electronic device of claim 12, wherein the prompt is presented in response to user input received at the user interface initiating another financial transaction reversing the financial transaction in response to the financial transaction reversal request communication and comprises a user actuation target that, when actuated, causes the communication device to transmit a financial transaction reversal validation communication to a remote electronic device across a network.

16. The electronic device of claim 15, wherein when the user interface receives user input requesting the communication device transmit a screenshot of the another financial transaction to another remote electronic device across the network, the one or more processors obscure one or more portions of the screenshot prior to the communication device transmitting the screenshot.

17. A method in an electronic device, the method comprising:
receiving, by a communication device of the electronic device, first electronic signals defining a financial transaction occurrence communication indicating that a financial transaction has occurred in a financial account of an authorized user of the electronic device;
also receiving, by the communication device within a predefined time duration from the first electronic signals, second electronic signals defining a financial transaction reversal request requesting that the financial transaction be reversed;
detecting, by a user interface of the electronic device, user input initiating another financial transaction reversing the financial transaction in response to the financial transaction reversal request; and
in response to receiving the first electronic signals, the second electronic signals within the predefined time duration from the first electronic signals, and the user input in response to the financial transaction reversal request, presenting, by one or more processors using the user interface of the electronic device, a prompt comprising a fraud warning indicating that the financial transaction reversal request is likely fraudulent.

18. The method of claim 17, further comprising receiving, by the user interface, an override of the fraud warning and completing, by the one or more processors, the another financial transaction.

19. The method of claim 17, further comprising capturing, by the one or more processors, a screenshot of a confirmation of the another financial transaction and obscuring at least some information depicted in the screenshot.

20. The method of claim 17, further comprising preventing, by the one or more processors, the another financial transaction after presenting the prompt.
